(19) United States
(12) Patent Application Publication
(10) Pub. No.: US 2023/0153691 A1
(43) Pub. Date: May 18, 2023

(54) Method for Generating Training Data for Training a Machine Learning Algorithm

(71) Applicant: Robert Bosch GmbH, Stuttgart (DE)

(72) Inventors: Konrad Groh, Stuttgart (DE); Matthias Woehrle, Bietigheim-Bissingen (DE)

(21) Appl. No.: 18/054,216

(22) Filed: Nov. 10, 2022

(30) Foreign Application Priority Data
Nov. 11, 2021 (DE) 10 2021 212 727.4

(51) Int. Cl. G06N 20/00

(52) U.S. Cl. CPC G06N 20/00

(57) ABSTRACT

A method is for generating training data for training a machine learning algorithm. The training data respectively include a data point and a data value associated with the data point. The method includes providing first training data for training the machine learning algorithm and approximating a manifold in which at least one part of the data points of the first training data is located. The method further includes determining a structure of the at least one part of the data points of the first training data in the manifold, and generating additional training data based on the determined structure of the at least one part of the data points of the first training data in the manifold.

This application claims priority under 35 U.S.C. § 119 to Patent Application No. DE 10 2021 212 727.4, filed on Nov. 11, 2021 in Germany, the disclosure of which is incorporated herein by reference in its entirety.

The disclosure relates to a method for generating training data for training a machine learning algorithm, and in particular to a method designed to generate additional training data in a simple manner and with low resource consumption.

### BACKGROUND

Machine learning algorithms are based on statistical methods being used to train a data processing system in such a way that it can perform a particular task without it being originally programmed explicitly for this purpose. The goal of machine learning is to construct algorithms that can learn and make predictions from data. These algorithms create mathematical models with which data can be classified, for example.

A system to be modeled can be acquired by means of measurements, for example, wherein an empirical model can be created based on measured values, for example, and a machine learning algorithm can be trained accordingly. However, in this case, situations in which it is impossible to completely measure a process to be modeled or a system to be modeled may, for example, occur. However, this may result in only partial data from a subspace being available for the empirical modeling or the corresponding training of the machine learning algorithm, wherein process states that are not captured by these training data can, however, also occur in operation.

As a solution to this problem, augmentation methods, i.e., methods for generating additional training data, have been proposed. However, with known augmentation methods, it proves disadvantageous that they are very complex and require many computer resources, in particular storage and computing capacities, so that they are difficult to realize with ordinary data processing systems.

A method for learning a data supplementation strategy for training a machine learning algorithm is known from the publication US 2019/0354895 A1, wherein training data for training a machine learning algorithm are received and a plurality of data supplementation strategies are determined by generating a current data supplementation strategy based on quality parameters of previous data supplementation strategies, the machine learning algorithm is trained based on the current data supplementation strategy and quality parameters with respect to the current data supplementation strategy are determined after the machine learning algorithm has been trained based on the current data supplementation strategy, wherein a data supplementation strategy is subsequently selected based on the quality parameters of the individual data supplementation strategies.

The disclosure is thus based on the object of specifying an improved method for generating training data for training a machine learning algorithm.

### SUMMARY

The object is achieved by a method for generating training data for training a machine learning algorithm as disclosed herein. The object is also achieved by a control device for generating training for training and a machine learning algorithm as disclosed herein. Advantageous embodiments and developments emerge from the dependent claims and from the description with reference to the figures.

According to one embodiment of the disclosure, this object is achieved by a method for generating training data for training a machine learning algorithm, wherein the training data respectively comprise a data point and a data value associated with the data point, and wherein first training data are provided for training the machine learning algorithm, a manifold in which at least one part of the data points of the first training data is located is approximated, a structure of the at least one part of the data points of the first training data in the manifold is determined, and additional training data are generated based on the structure of the at least one part of the data points of the first training data in the manifold.

Data points are understood herein as information carriers or units of information representing input variables of the machine learning algorithm, i.e., data that can be processed by the machine learning algorithm.

Data values or function values are furthermore understood as information carriers and units of information respectively representing an output variable of the machine learning algorithm, i.e., an output variable generated by processing a corresponding input variable by means of the machine learning algorithm.

A manifold is understood to mean a structure with which points in an n-dimensional space can be represented or determined with (n-1) or fewer coordinates. A manifold in which at least one part of the data points of the first training data is located being approximated thus means that data points from an n-dimensional space corresponding to the at least one part of the data points of the first training data in the manifold can be determined in (n-1) or less coordinates.

The structure of the at least one part of the data points of the first training data in the manifold is furthermore understood as a connection, or a mathematical relationship, between the coordinates of the respective data points in the manifold.

Approximating a manifold in which at least one part of the data points of the first training data is located, wherein the additional training data is subsequently generated based on the approximated manifold, has the advantage that the number of dimensions or coordinates to be processed during the generation of additional training data can be significantly reduced and the effort associated with the generation of additional training data can thus be significantly simplified.

Generating the additional training data based on the structure of the at least one part of the data points of the first training data in the manifold moreover has the advantage that interdependencies of the training data are considered and the generated additional training data are consistent with the at least one part of the first training data, for example all have a certain property.

Overall, a method is thus specified with which the generation of additional training data can be significantly simplified and additional training data can be generated in a simple manner and with comparatively low resource consumption, e.g., low storage and/or computing capacities. For example, if the first training data are time points from time series, the effort associated with generating additional training data can be significantly simplified so that the method can in particular even be performed on control devices with limited computer resources.

Overall, an improved method for generating training for training a machine learning algorithm is thus specified.

In one embodiment, the step of approximating the at least one manifold in which the at least one part of the data points of the first training data is located comprises, for each data point from the first training data, determining the nearest neighbors of the respective data point within the data points of the first training data, wherein, for each data point of the first training data, the structure of the at least one part of the data points of the first training data in the manifold is respectively determined based on the data point and the nearest neighbors of the respective data point. The approximation of the manifold or the generation of the additional training data can thus take place in a simple manner based on the respective nearest neighbors and especially a neighborhood graph, i.e., with comparatively low computer resources.

The structure of the at least one part of the data points of the first training data in the manifold may be determined, for example, based on a main component analysis.

In this case, for each data point of the first training data, the nearest neighbors can be determined based on the Euclidean norm.

The Euclidean norm or standard norm serves to determine the distance between two points or vectors, especially in a two- or three-dimensional space.

The nearest neighbors may thus also be respectively determined in a simple manner and with low consumption of computer resources.

The nearest neighbors being determined based on the Euclidean norm is, however, only one possible embodiment. Rather, the nearest neighbors may also be determined based on other methods for determining a distance between individual data points.

Furthermore, for each data point in the additional training data, the method may furthermore comprise respectively determining a data value for the respective data point based on data values associated with the nearest neighbors of the respective data point.

In particular, since the nearest neighbors have already been determined during the generation of the additional training data, the corresponding data values can thus also be determined without great effort and with low computer resources.

The first training data may furthermore be sensor data or data captured by a sensor.

A sensor, which is also referred to as a detector, (measurement or measuring) sensor or (measuring) transmitter, is a technical part that can qualitatively detect particular physical or chemical properties and/or the material characteristics of its surroundings or detect them quantitatively as a measured variable.

Thus, circumstances outside the actual data processing system on which the additional training data are generated can be captured in a simple manner and can be taken into account when generating the additional training data.

With a further embodiment of the disclosure, a method for training a machine learning algorithm is also specified, wherein first training data and additional training data are provided by a method described above for generating training data for training a machine learning algorithm, and wherein the machine learning algorithm is trained based on the first training data and the additional training data.

A method for training a machine learning algorithm which is based on training data generated by an improved method for generating training data for training a machine learning algorithm is thus specified. In particular, the method is based on a method for generating training data for training a machine learning algorithm, with which the generation of additional training data can be significantly simplified and additional training data can be generated in a simple manner and with comparatively low resource consumption, e.g., low storage and/or computing capacities. For example, if the first training data are time points from time series, the effort associated with generating additional training data can be significantly simplified so that the method for generating training data for training the machine learning algorithm can in particular even be performed on control devices with limited computer resources.

With a further embodiment of the disclosure, a method for controlling at least one function of a controllable system is furthermore also specified, wherein a machine learning algorithm is provided for controlling the at least one function of the controllable system, wherein the machine learning algorithm has been trained by a method described above for training a machine learning algorithm, and wherein the at least one function of the controllable system is controlled based on the machine learning algorithm.

The controllable system may, for example, be a robotic system, wherein the robotic system may, for example, be an injection system of an internal combustion engine. Furthermore, the robotic system may, for example, however also be any other system that can be controlled based on a machine learning algorithm, e.g., driver assistance systems of a motor vehicle, a kitchen appliance or a washing machine.

A method is thus specified for controlling at least one function of a controllable system that is based on a machine learning algorithm that has been trained based on training data generated by an improved method for generating training data for training a machine learning algorithm. In particular, the training data in this case have been generated by a method for generating training data for training a machine learning algorithm, with which the generation of additional training data can be significantly simplified and additional training data can be generated in a simple manner and with comparatively low resource consumption, e.g., low storage and/or computing capacities. For example, if the first training data are time points from time series, the effort associated with generating additional training data can be significantly simplified so that the method for generating training data for training the machine learning algorithm can in particular even be performed on control devices with limited computer resources.

With a further embodiment of the disclosure, a control device for generating training data for training a machine learning algorithm is furthermore also specified, wherein the training data respectively comprise a data point and a data value, and wherein the control device comprises a provision unit designed to provide first training data, an approximation unit designed to approximate a manifold in which at least one part of the data points of the first training data is located, a determination unit designed to determine a structure of the at least one part of the data points of the first training data in the manifold, and a generation unit designed to generate additional training data based on the structure of the at least one part of the data points of the first training data in the manifold.

Overall, an improved control device for generating training data for training a machine learning algorithm is thus specified. In particular, a control device is specified with which the generation of additional training data can be significantly simplified and additional training data can be generated in a simple manner and with comparatively low resource consumption, e.g., low storage and/or computing capacities. For example, if the first training data are time points from time series, the effort associated with generating additional training data can be significantly simplified so that the control device can in particular even be a control device with limited computer resources.

In one embodiment, the approximation unit is designed to determine, for each data point from the first training data, the nearest neighbors within the data points of the first training data in order to approximate the manifold in which the at least one part of the data points of the first training data is located, wherein the determination unit is designed to respectively determine, for each data point from the first training data, the structure of the at least one part of the data points of the first training data in the manifold based on the data point and the nearest neighbors of the respective data point. The approximation of the manifold or the generation of the additional training data can thus take place in a simple manner based on the respective nearest neighbors and especially a neighborhood graph, i.e., with comparatively low computer resources.

The structure of the at least one part of the data points of the first training data in the manifold can in this case again be determined, for example, based on a main component analysis, i.e., the determination unit can be designed accordingly.

The approximation unit can furthermore be designed to respectively determine, for each data point from the first training data, the nearest neighbors based on the Euclidean norm. The nearest neighbors may thus also be respectively determined in a simple manner and with low consumption of computer resources.

Moreover, the control device may furthermore comprise a determination unit designed to respectively determine, for each data point in the additional training data, a data value for the respective data point based on data values associated with the nearest neighbors of the respective data point. In particular, since the nearest neighbors have already been determined during the generation of the additional training data, the corresponding data values can thus also be determined without great effort and with low computer resources.

Again, the first training data may furthermore be sensor data or data captured by a sensor. Thus, circumstances outside the actual data processing system on which the additional training data are generated can be captured in a simple manner and can be taken into account when generating the additional training data.

With a further embodiment of the disclosure, a control device for training a machine learning algorithm is furthermore also specified, wherein the control device comprises a provision unit designed to provide first training data and additional training data, wherein the additional training data have been generated by a control device described above for generating training data for training a machine learning algorithm, and a training unit designed to train the machine learning algorithm based on the first training data and the additional training data.

A control device for training a machine learning algorithm, which is designed to train a machine learning algorithm based on training data generated by an improved method for generating training data for training a machine learning algorithm, is thus specified. In particular, the additional training data in this case are generated by a method for generating training data for training a machine learning algorithm, with which the generation of additional training data can be significantly simplified and additional training data can be generated in a simple manner and with comparatively low resource consumption, e.g., low storage and/or computing capacities. For example, if the first training data are time points from time series, the effort associated with generating additional training data can be significantly simplified so that the corresponding method for generating training data for training the machine learning algorithm can in particular even be performed on control devices with limited computer resources.

With a further embodiment of the disclosure, a control device for controlling at least one function of a controllable system is furthermore also specified, wherein the control device comprises a provision unit designed to provide a machine learning algorithm for controlling the at least one function of the controllable system, wherein the machine learning algorithm has been trained by a control device described above for training a machine learning algorithm, and a control unit designed to control the at least one function of the controllable system based on the machine learning algorithm.

A control device is thus specified for controlling at least one function of a controllable system that is based on a machine learning algorithm that has been trained based on training data generated by an improved method for generating training data for training a machine learning algorithm. In particular, the training data in this case have been generated by a method for generating training data for training a machine learning algorithm, with which the generation of additional training data can be significantly simplified and additional training data can be generated in a simple manner and with comparatively low resource consumption, e.g., low storage and/or computing capacities. For example, if the first training data are time points from time series, the effort associated with generating additional training data can be significantly simplified so that the method for generating training data for training the machine learning algorithm can in particular even be performed on control devices with limited computer resources.

In summary, it must be noted that the disclosure specifies a method for generating training data for training a machine learning algorithm, and in particular a method designed to generate additional training data in a simple manner and with low resource consumption.

The described embodiments and developments can be combined with one another as desired.

Other possible embodiments, developments and implementations of the disclosure also include not explicitly mentioned combinations of features of the disclosure described above or below with respect to exemplary embodiments.

### BRIEF DESCRIPTION OF THE DRAWINGS

The accompanying drawings are intended to provide a further understanding of the embodiments of the disclosure. They illustrate embodiments and, in connection with the description, serve to explain principles and concepts of the disclosure.

Other embodiments and many of the mentioned advantages become apparent from the drawings. The illustrated elements of the drawings are not necessarily shown to scale with respect to one another. In the figures:

FIG. 1 shows a flow chart of a method for controlling at least one function of a controllable system according to embodiments of the disclosure; and

FIG. 2 shows a schematic block diagram of a system for controlling at least one function of a controllable system according to embodiments of the disclosure.

### DETAILED DESCRIPTION

In the figures of the drawings, identical reference numbers denote identical or functionally identical elements, parts or components, unless stated otherwise.

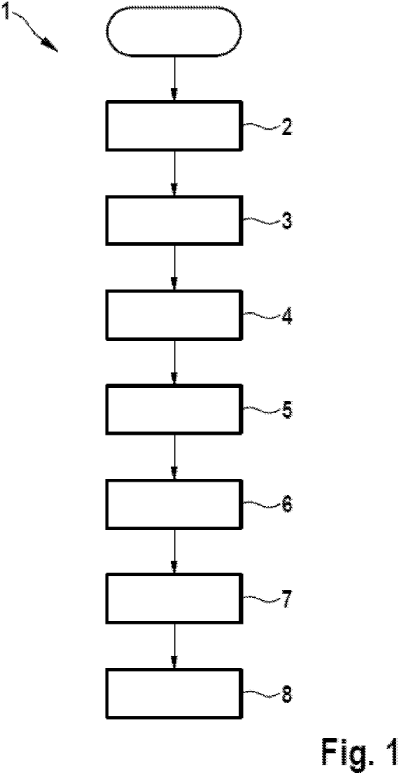

FIG. 1 shows a flow chart of a method 1 for controlling at least one function of a controllable system according to embodiments of the disclosure.

Machine learning algorithms are based on statistical methods being used to train a data processing system in such a way that it can perform a particular task without it being originally programmed explicitly for this purpose. The goal of machine learning is to construct algorithms that can learn and make predictions from data. These algorithms create mathematical models with which data can be classified, for example.

A system to be modeled can be acquired by means of measurements, for example, wherein an empirical model can be created based on measured values, for example, and a machine learning algorithm can be trained accordingly. However, in this case, situations in which it is impossible to completely measure a process to be modeled or a system to be modeled may, for example, occur. However, this may result in only partial data from a subspace being available for the empirical modeling or the corresponding training of the machine learning algorithm, wherein process states that are not captured by these training data can, however, also occur in operation.

As a solution to this problem, augmentation methods, i.e., methods for generating additional training data, have been proposed. For example, it is known to augment data by Gaussian noise or image data by image processing methods. However, with known augmentation methods, it proves disadvantageous that they are very complex and require many computer resources, in particular storage and computing capacities, so that they are difficult to realize with ordinary data processing systems.

FIG. 1 shows a method 1, wherein, in a first step 2, first training data are provided for training the machine learning algorithm, wherein the first training data respectively have a data point and a data value, in a step 3, a manifold in which at least one part of the data points of the first training data is located, i.e., all data points contained or included in the first training data, is approximated, in a step 4, a structure of the at least one part of the data points of the first training data in the manifold is determined, and in a step 5, additional training data are generated based on the structure of the at least one part of the data points of the first training data in the manifold.

FIG. 1 thus shows a method 1 in which new training data are generated with the aid of a manifold model, wherein the method 1 utilizes the fact that the first training data or the respective data points are located on a manifold.

Overall, FIG. 1 shows a method 1 with which the generation of additional training data can be significantly simplified and additional training data can be generated in a simple manner and with comparatively low resource consumption, e.g., low storage and/or computing capacities. For example, if the first training data are time points from time series, the effort associated with generating additional training data can be significantly simplified so that the method 1 can in particular even be performed on control devices with limited computer resources.

The first training data may, for example, be measured values that show relationships between input and output values of a function controlled by the machine learning algorithm and based on which the machine learning algorithm is to be trained.

Furthermore, the training data generated by the method 1 may also be used to test or validate an already trained machine learning algorithm.

According to the embodiment of FIG. 1, the manifold in which at least one part of the first training data is located can be approximated locally linearly based on a neighborhood graph. In particular, the step 3 of approximating the manifold in which the at least one part of the data points of the first training data is located comprises, for each data point from the first training data, determining the nearest neighbors of the data point within the data points of the first training data, i.e., among all data points of the first training data, wherein, for each data point from the first training data, the structure of the at least one part of the data points of the first training data in the manifold is respectively determined based on the data point and the nearest neighbors of the respective data point in step 4.

The structure of the at least one part of the data points of the first training data in the manifold is determined, according to the embodiments of FIG. 1, based on a main component analysis in step 4. In particular, a main component analysis is performed for a data point from the first training data, which results in the following local linear approximation of the data:

$$x \approx {\text{x}}_{0} + {λ}_{1} {ζ}_{1} + … + {λ}_{\text{N}} {ζ}_{\text{N}}$$

wherein x₀ is the mean value of the N nearest neighbors of the respective data point, ζ₁ to ζ_{N} are respectively the main components, determined from the main component analysis, of the neighbors 1 to N of the respective data point, and λ₁ to λ_{N} are respectively coefficients.

According to the embodiments of FIG. 1, the additional training data are generated in step 5 by varying the coefficients λ₁ to λ_{N}, wherein small values are preferably respectively added or subtracted.

According to the embodiments of FIG. 1, for each data point from the first training data, the nearest N neighbors are respectively determined based on the Euclidean norm.

As FIG. 1 furthermore shows, the method 1 moreover comprises a step 6 of respectively determining a data value for each data point in the additional training data based on data values associated with the nearest neighbors of the respective data point. In so doing, the data value may be determined by majority vote if the machine learning algorithm is to classify data and may be determined by averaging if the machine learning algorithm is to continuously output output values.

The data values associated with the nearest neighbors can in this case be read from the corresponding first training data.

According to the embodiments of FIG. 1, the first training data furthermore comprise sensor data. The sensor data may, for example, be acquired from an optical sensor, such as a video sensor, a RADAR, a LiDAR, or a motion sensor, for example.

Steps 2, 3, 4, 5, and 6 may be performed repeatedly, particularly until sufficient training data for training the machine learning algorithm are available.

As FIG. 1 furthermore shows, method 1 furthermore comprises a step 7 of training the machine learning algorithm based on the first training data and the generated additional training data.

Moreover, FIG. 1 shows a step 8 of controlling at least one function of a controllable system based on the trained machine learning algorithm.

The controllable system may, for example, be an injection system of an internal combustion engine, wherein the machine learning algorithm is designed in such a way that the respective opening and/or closing time point of the injection valve can be determined based on a data-based time point determination model.

Furthermore, the controllable system may, for example, be an analyzer, e.g., an analyzer for analyzing samples for the presence of viruses, wherein the method can be applied to corresponding image data.

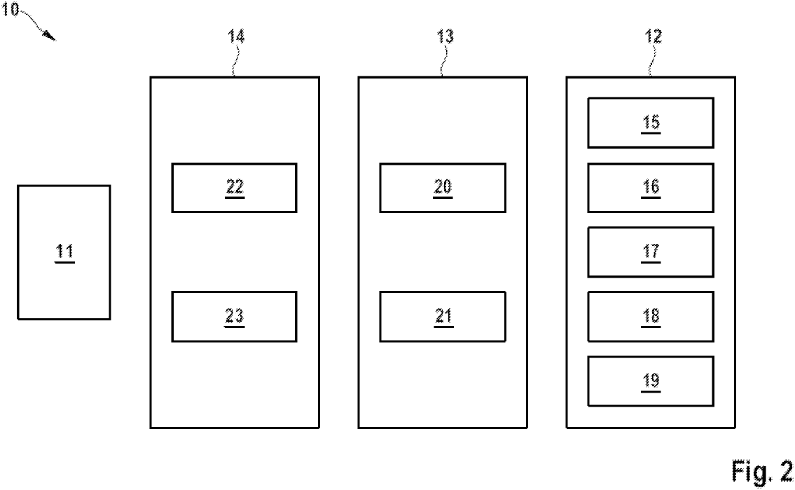

FIG. 2 shows a schematic block diagram of a system 10 for controlling at least one function of a controllable system 11 according to embodiments of the disclosure.

The controllable system 11 may, for example, be a robotic system, wherein the robotic system may, for example, be an injection system of an internal combustion engine. Furthermore, the robotic system may, for example, however also be any other system that can be controlled based on a machine learning algorithm, e.g., driver assistance systems of a motor vehicle, a kitchen appliance or a washing machine.

As FIG. 2 shows, the system 10 comprises a control device 12 for generating training data for training the machine learning algorithm, a control device 13 for training the machine learning algorithm, and a control device 14 for controlling at least one function of a controllable system.

According to the embodiments of FIG. 2, the control device 12 for generating training data for training the machine learning algorithm comprises a provision unit 15 designed to provide first training data, wherein the first training data respectively comprise a data point and a data value associated with the data point, an approximation unit 16 designed to approximate a manifold in which at least one part of the data points of the first training data is located, a determination unit 17 designed to determine a structure of the at least one part of the data points of the first training data in the manifold, and a generation unit 18 designed to generate additional training data based on the structure of the at least one part of the data points of the first training data in the manifold.

The provision unit may, for example, be designed as a receiver, wherein the receiver is designed to receive the first training data, e.g., sensor data. The approximation unit, the determination unit and the generation unit may furthermore respectively be implemented, for example, based on code that is stored in a memory and can be executed by a processor.

According to the embodiments of FIG. 2, the approximation unit 16 is furthermore designed to respectively determine, for each data point from the first training data, the nearest neighbors within the data points of the first training data in order to approximate the manifold in which the at least one part of the data points of the first training data is located, wherein the determination unit 17 is designed to respectively determine, for each data point from the first training data, the structure of the at least one part of the data points of the first training data in the manifold based on the data point and the nearest neighbors of the respective data point.

In particular, the approximation unit 16 is designed to respectively determine, for each data point from the first training data, the nearest neighbors based on the Euclidean norm.

As FIG. 2 furthermore shows, the control device 12 moreover comprises a determination unit 19 designed to respectively determine, for each data point in the additional training data, a data value for the respective data point based on data values associated with the nearest neighbors of the respective data point.

Again, the application unit may furthermore be implemented, for example, based on code that is stored in a memory and can be executed by a processor.

According to the embodiments of FIG. 2, the first training data are furthermore again sensor data.

As FIG. 1 furthermore shows, the control device 13 for training the machine learning algorithm furthermore comprises a further provision unit 20 designed to provide first training data and additional training data, wherein the additional training data have been generated by the control device 12 for generating training data for training a machine learning algorithm, and a training unit 21 designed to train the machine learning algorithm based on the first training data and the additional training data.

The further provision unit may, for example, again be designed as a receiver, wherein the receiver is designed to receive the generated additional training data and optionally also the first training data from the control device for generating training data for training the machine learning algorithm. Again, the training unit may furthermore be implemented, for example, based on code that is stored in a memory and can be executed by a processor.

As FIG. 2 moreover shows, the control device 14 for controlling at least one function of a controllable system yet comprises a further provision unit 22 designed to provide the machine learning algorithm for controlling the at least one function of the controllable system, wherein the machine learning algorithm has been trained by the control device 13 for training the machine learning algorithm, and a control unit 23 designed to control the at least one function of the controllable system based on the machine learning algorithm.

The provision unit may, for example, again be designed as a receiver, wherein the receiver is designed to receive the trained machine learning algorithm from the control device for training the machine learning algorithm. The control unit may furthermore comprise corresponding actuators and/or may again at least in part be implemented, for example, based on code that is stored in a memory and can be executed by a processor.

What is claimed is:

1. A method for generating training data for training a machine learning algorithm, the training data respectively comprise a data point and a data value associated with the data point, the method comprising:
providing first training data for training the machine learning algorithm;
approximating a manifold in which at least one part of the data points of the first training data is located;
determining a structure of the at least one part of the data points of the first training data in the manifold; and
generating additional training data based on the determined structure of the at least one part of the data points of the first training data in the manifold.

2. The method according to claim 1, wherein:
approximating the manifold in which the at least one part of the data points of the first training data is located comprises for each data point from the first training data, determining nearest neighbors of the respective data point within the data points of the first training data, and
for each data point from the first training data, the structure of the at least one part of the data points of the first training data in the manifold is respectively determined based on the data point and the nearest neighbors of the respective data point.

3. The method according to claim 2, wherein, for each data point from the first training data, the nearest neighbors are determined based on a Euclidean norm.

4. The method according to claim 2, further comprising:
respectively determining, for each data point in the additional training data, a data value for the respective data point based on data values associated with the nearest neighbors of the respective data point.

5. The method according to claim 1, wherein the first training data comprise sensor data.

6. A method for training a machine learning algorithm, comprising:
providing first training data and generating additional training data according to the method of claim 1; and
training the machine learning algorithm based on the first training data and the additional training data.

7. A method for controlling at least one function of a controllable system, comprising:
providing a machine learning algorithm for controlling the at least one function of the controllable system, the machine learning algorithm having been trained according to the method of claim 6; and
controlling the at least one function of the controllable system based on the trained machine learning algorithm.

8. A control device for generating training data for training a machine learning algorithm, the training data respectively comprise a data point and a data value associated with the data point, the control device comprising:
a provision unit configured to provide first training data;
an approximation unit configured to approximate a manifold in which at least one part of the data points of the first training data is located;
a determination unit configured to determine a structure of the at least one part of the data points of the first training data in the manifold; and
a generation unit configured to generate additional training data based on the determined structure of the at least one part of the data points of the first training data in the manifold.

9. The control device according to claim 8, wherein:
the approximation unit is configured to respectively determine, for each data point of the first training data, nearest neighbors within the data points of the first training data in order to approximate the manifold in which the at least one part of the data points of the first training data is located, and
the determination unit is configured to respectively determine, for each data point from the first training data, the structure of the at least one part of the data points of the first training data in the manifold based on the data point and the nearest neighbors of the respective data point.

10. The control device according to claim 9, wherein the approximation unit is configured to respectively determine, for each data point from the first training data, the nearest neighbors based on a Euclidean norm.

11. The control device according to claim 9, further comprising:
a determination unit configured to respectively determine, for each data point in the additional training data, a data value for the respective data point based on data values associated with the nearest neighbors of the respective data point.

12. The control device according to claim 8, wherein the first training data comprise sensor data.

13. A control device for training a machine learning algorithm, comprising:
a provision unit configured to provide first training data and to generate additional training data, the additional training data having been generated by the control device of claim 8; and
a training unit configured to train the machine learning algorithm based on the first training data and the additional training data.

14. A control device for controlling at least one function of a controllable system, comprising:
a provision unit configured to provide a machine learning algorithm for controlling the at least one function of the controllable system, the machine learning algorithm trained by the control device of claim 13; and
a control unit configured to control the at least one function of the controllable system based on the machine learning algorithm.
